(19) United States
(12) Patent Application Publication
(10) Pub. No.: US 2018/0372124 A1
(43) Pub. Date: Dec. 27, 2018

(54) Intelligent Failure Self-Diagnostic Convertible Jet Pump

(71) Applicant: GP Enterprises Co., Ltd, Suzhou (CN)

(72) Inventor: Xian Wang, Suzhou (CN)

(21) Appl. No.: 16/128,507

(22) Filed: Sep. 12, 2018

Related U.S. Application Data
(63) Continuation-in-part of application No. PCT/CN2017/088146, filed on Jun. 13, 2017.

(30) Foreign Application Priority Data
May 23, 2017 (CN) 201720575920.5

(51) Int. Cl. F04F 5/48; H02K 5/20; H02P 29/024; F04F 5/24

(52) U.S. Cl. CPC F04F 5/48; F04F 5/24; H02P 29/024; H02K 5/20

(57) ABSTRACT

An intelligent failure self-diagnostic convertible jet pump includes a control circuit system, a drive motor, a junction box, a light guide column and hydraulic components. The control circuit system includes a signal acquisition circuit, a MCU circuit, a drive circuit and an alarm display circuit. The control circuit system is disposed in the junction box and connected to the drive motor. The junction box is fixed on the surface of the motor housing using via screws and locking mechanism. The light guide column is fixed on the junction box and connected to the diagnostic control panel of the control circuit system. The hydraulic components include a venturi, a diffuser and an impeller. The impeller is coaxially connected to the drive motor.

### CROSS REFERENCE TO RELATED APPLICATIONS

The present application is a Continuation-In-Part Application of PCT Application No. PCT/CN2017/088146 filed on Jun. 13, 2017, which claims the benefit of Chinese Patent Application No. 201720575920.5 filed on May 23, 2017. All the above are hereby incorporated by reference.

### TECHNICAL FIELD

The present invention is relates to a water pump, and specifically relates to an intelligent failure self-diagnostic convertible jet pump which belongs to the technical field of water pump.

### BACKGROUND OF THE INVENTION

In the United States and Europe household water pump industry, convertible jet pumps are traditionally controlled by mechanical method without failure self-diagnostic function and there is no way to eliminate defects such as leakage, overload and no load leading by improper installation. So adding failure self-diagnostic function and troubleshooting ability on the basis of the existing pump can bring great convenience to the customer's operation and maintenance and have important effects on promoting products and occupying the market.

### SUMMARY OF THE INVENTION

The purpose of the present invention is to provide an intelligent failure self-diagnostic convertible jet pump which has a circuit control system of quick fault-detection and protection and improved the heat dissipation performance and working efficiency of the pump at the same time to greatly extend the service life of the pump and reduce maintenance cost subsequently.

The technical solution of the present invention is provided with an intelligent failure self-diagnostic convertible jet pump, which includes a control circuit system, a drive motor, a junction box, a light guide column and hydraulic components. The control circuit system includes a signal acquisition circuit, a MCU circuit, a drive circuit and an alarm display circuit. The control circuit system is placed inside the junction box and connects to the drive motor. The drive motor is placed inside a motor housing. The junction box is fixed on the surface of the motor housing via screws and locking mechanism. The light guide column is fixed on the junction box and connects to the diagnostic control panel of the control circuit system. The hydraulic components include a venturi, a diffuser and an impeller. The impeller is c coaxially connected to the driving motor. The drive circuit is integrated with silicon controlled rectifier. The alarm display circuit provided with a light and connects to light guide column correspondingly. The control circuit system real-time monitors and analysis the collected operation condition data collected by the signal acquisition circuit and takes the corresponding protective measures and the light on the alarm display circuit simultaneously provides trouble indication. When the water pump works at the condition of overload or light load or normal operation, the light guide column will display different colors and frequency and controls the silicon controlled rectifier by the drive circuit to control and prevent the drive motor from damage according to the drive circuit signal.

In a preferred embodiment of the present invention, the motor housing inside is provided with air inlets, the back end cover is provided with air outlets which form air-cooling channels.

In a preferred embodiment of the present invention, the upper surface of the motor housing is partially provided with cooling grooves which located on the air cooling channels, the cooling grooves and the silicon controlled rectifier are arranged correspondingly.

In a preferred embodiment of the present invention, silicon controlled rectifier (SCR) is fixedly connected using fixed linkage mechanism, the SCR fixed linkage mechanism includes a guide slot, a heat dissipation block, a locking block and screws, the guide slot is disposed within the junction box, the dissipation block is embedded in the guide slot and tightly adhered to the surface of the cooling groove surface, the locking block clamps the SCR with screws.

In a preferred embodiment of the present invention, the outer edge of the diffuser is provided with water inlets and water outlets forms multiple sets of diversion channels, the diversion channel is sloped through the front and rear surfaces of the diffuser, the diffuser surface on the side of water outlet is provided with multiple channel walls which correspondingly match with the flow channels, the channel walls are in the shape of arc and the outer arc surface of the channel walls is closed.

The present invention disclosed an intelligent, failure self-diagnostic convertible jet pump which adds a circuit control system of quick fault-detection and protection and improved the heat dissipation performance and working efficiency of the pump at the same time to greatly extend the service life of the pump and reduce maintenance cost.

### BRIEF DESCRIPTION OF THE FIGURES

In order to more clearly illustrate the technical solutions in the embodiments of the present invention, the drawings used in the description of the embodiments will be briefly described below. Obviously, the drawings in the following description are merely some embodiments of the present invention. For those who skilled in the art, other drawings may also be obtained based on these drawings without paying any creative work. Therein:

FIG. 1 is a schematic structural view of a preferred embodiment of an intelligent control, failure self-diagnostic convertible jet pump according to the present invention;

FIG. 2 is a perspective structural view of the control circuit system on the upper surface of the motor housing of a preferred embodiment of an intelligent control, failure self-diagnostic convertible jet pump according to the present invention;

FIG. 3 is an explosion structural view of the junction box and diagnostic circuit board of a preferred embodiment of an intelligent control, failure self-diagnostic convertible jet pump according to the present invention;

FIG. 4 is a schematic structural view of the diffuser of a preferred embodiment of an intelligent control, failure self-diagnostic convertible jet pump according to the present invention;

FIG. 5 is a schematic structural view of the junction box and silicon control rectifier fixing mechanism on motor housing of a preferred embodiment of an intelligent control, failure self-diagnostic convertible jet pump according to the present invention.

### DETAILED DESCRIPTION

The following clearly and completely describes of the technical solutions in the embodiments of the present invention in order to that the advantages and characteristics of the present invention can be understood easily by the technicians in this field and can clearly define the protection scope of the present invention.

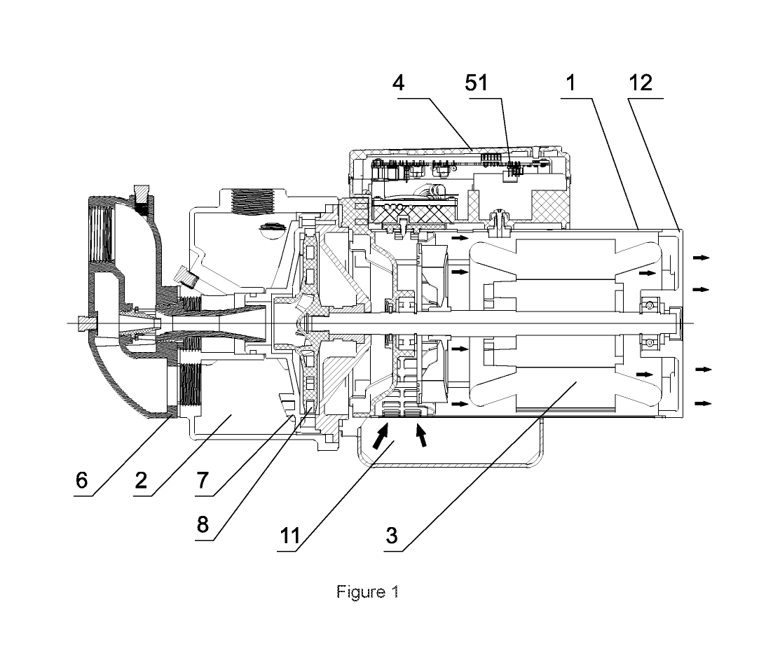

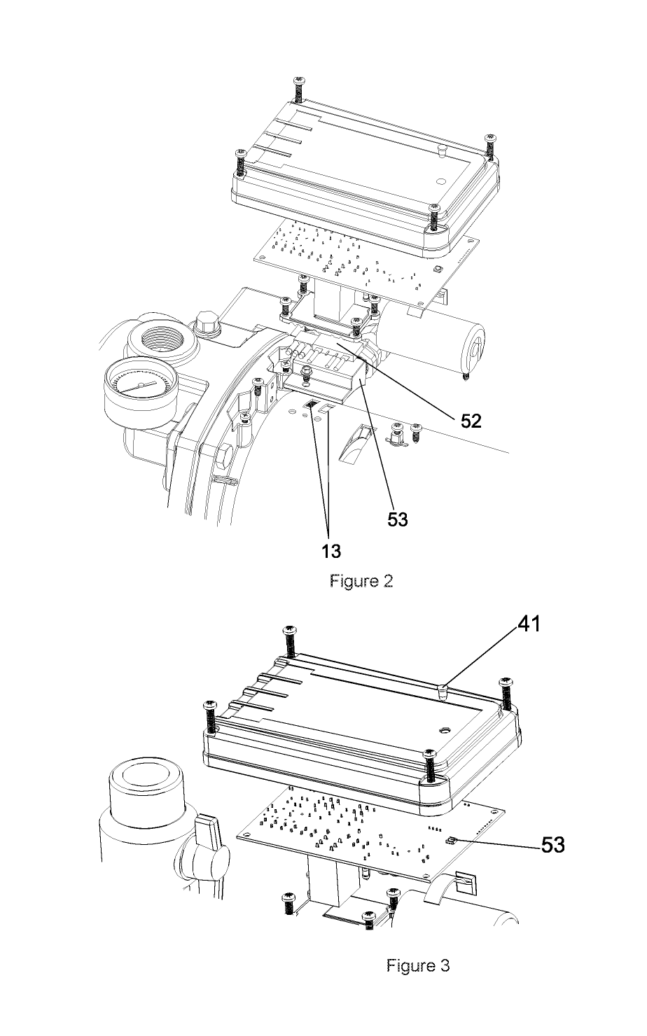

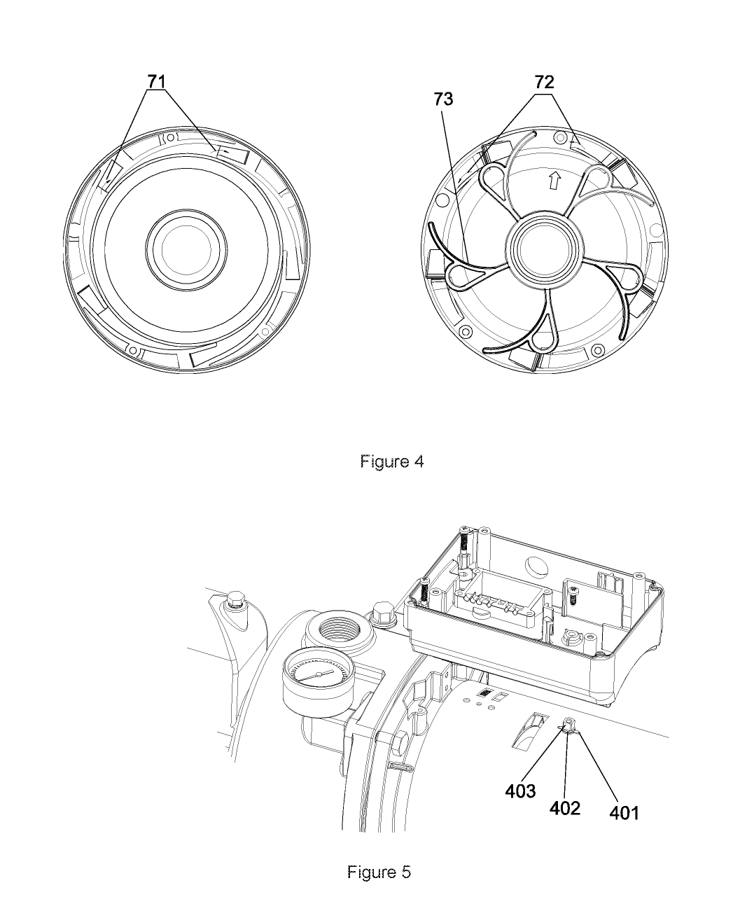

The present invention relates to an intelligent failure self-diagnostic convertible jet pump as shown in FIG. 1, FIGS. 2-5, which includes a control circuit system 5, a drive motor 3, a junction box 4, a light guide column 41 and hydraulic components 2. The control circuit system 5 includes a signal acquisition circuit, a MCU circuit, a drive circuit and an alarm display circuit. The control circuit system 5 is disposed inside the junction box 4 and connected to the drive motor 3. The drive motor 3 is placed inside a motor housing 1. The junction box 4 is fixed on the surface of the motor housing 1 via screws and locking mechanism. The light guide column 41 is fixed on the junction box 4 and connected to the diagnostic control panel 51 of the control circuit system 5. The hydraulic components 2 include a venturi 6, a diffuser 7 and an impeller 8. The impeller 8 is coaxially connected to the driving motor 3. The drive circuit is integrated with the silicon controlled rectifier 52. The alarm display circuit disposed with a light 53 and correspondingly connected to the light guide column 41. The control circuit system 5 real-time monitors and analysis the collected operation condition data collected by the signal acquisition circuit and takes the corresponding protective measures and the light 53 on the alarm display circuit provides trouble indication simultaneously. When the water pump works at the condition of overload or light load or normal operation, the light guide column 41 displays different color and frequency, meanwhile the drive circuit controls the silicon controlled rectifier 52 according to the drive circuit signal to control and prevent the drive motor from damage.

The motor housing 1 is provided with air inlets 11, the back end cover is provided with air outlets 12 which form air-cooling channels.

The upper surface of the motor housing is partially provided with cooling grooves 13 which located on the air cooling channels, the cooling grooves 13 and the silicon controlled rectifier 52 are arranged correspondingly.

The silicon controlled rectifier (SCR) 52 is fixedly connected via fixed linkage mechanism, the SCR fixed linkage mechanism includes a guide slot 401, a heat dissipation block 402, a locking block 403 and screws. The guide slot 401 is disposed within the junction box 4. The dissipation block 402 is embedded in the guide slot 401 and tightly adhered to the surface of the cooling groove 13. The locking block 403 tightly presses the SCR 52 via screw.

The outer edge of the diffuser 7 is provided with water inlets 71 and water outlets 72 to form multiple sets of diversion channels. The diversion channel is sloped through the front and rear surfaces of the diffuser 7. The diffuser 7 surface on the side of water outlet 72 is provided with multiple channel walls 73 which correspondingly match with the flow channels. The channel walls 73 are in the shape of arc and the outer arc surface of the channel walls is closed.

Under working condition, the air goes into the drive motor from the air inlets and goes through stator core then discharges from the air outlets, so as to achieve uninterrupted cooling effect to the stator and the rotor. In the process, the heat transferred from the silicon control rectifier to the heat dissipation block is simultaneously dissipated, therefore the heat dissipation performance significantly improved.

The control circuit system carries out real-time monitoring and analysis of the current data of the driving motor and displays it visually by the indicator and light guide. When current overload is detected by the control circuit system, the light guide column turns to red and flashes to illustrate to the user on pump's blocking, overload or overheat. When the control circuit system detected that the current is lower than the set value, the light guide column turns to blue and flashes to illustrate to the user on pump dry-running occurrence. When the control circuit system detects that the frequency of on-off power exceeds the set value, the light guide column turns to yellow and flashes to indicate pump starts too frequently. When the control circuit system detects that the current value is within the set value range, the light guide column keeps green. When the control circuit system detects that the current is within the set value range and pump is not working, the light guide column turns to green breathing mode.

The motor housing is provided with a guide slot which makes the junction box can be easily removed from the pump for maintenance.

During the process of work, the water flow enters into the diffuser from the inlets and flows along the smooth curved flow channel walls which greatly reduce the loss of frictional resistance so effectively enhanced the efficiency of the pump in the scale of more than 10%.

The present invention describes an intelligent, failure self-diagnostic convertible jet pump which adds a circuit control system that is capable to quick fault-detection and protection, and at the same time improved the heat dissipation performance and efficiency of the pump therefore greatly extended the service life of the pump and reduced the maintenance cost.

The foregoing descriptions are merely embodiments of the present invention, and therefore do not mean to limit the scope of the present invention. Any implementation on the content of the present specification by using an alternative structure or equivalent process transformation without any creative labor should be covered within the scope of protection of the present invention. Therefore, the scope of protection of the invention shall be subject to the scope of protection specified in the patent claim.

What is claimed is:

1. A type of an intelligent failure self-diagnostic convertible jet pump, comprising a control circuit system, a drive motor, a junction box, a light guide column and hydraulic components; wherein the control circuit system includes a signal acquisition circuit, a MCU circuit, a drive circuit, and an alarm display circuit, and said control circuit system is disposed inside the junction box and connected to the drive motor; the drive motor is placed inside a motor housing; the junction box is fixed on the surface of the motor housing via screws and locking mechanism; the light guide column is fixed on the junction box and connected to the diagnostic control panel of the control circuit system; the hydraulic components include a venturi, a diffuser and an impeller: the impeller is coaxially connected to the driving motor; the drive circuit is integrated with silicon controlled rectifier; the alarm display circuit disposed with a light and correspondingly connected to the light guide column; the control circuit system real-time monitors and analysis the collected operation condition data collected by the signal acquisition circuit and takes the corresponding protective measure and the light on the alarm display circuit provides trouble indication simultaneously; when the water pump works at the condition of overload or light load or normal operation, the light guide column displays different color and frequency, meanwhile the drive circuit controls the silicon controlled rectifier according to the drive circuit signal to control and prevent the drive motor from damage.

2. The intelligent failure self-diagnostic convertible jet pump according to claim 1, characterized in that the inside of motor housing is provided with air inlets, the back end cover is provided with air outlets which form air-cooling channels.

3. The intelligent failure self-diagnostic convertible jet pump according to claim 2, characterized in that the upper surface of the motor housing is partially provided with cooling grooves which located on the air cooling channels, the cooling grooves and the silicon controlled rectifier are arranged correspondingly.

4. The intelligent failure self-diagnostic convertible jet pump according to claim 3, characterized in that the silicon controlled rectifier (SCR) is fixedly connected via fixed linkage mechanism, the SCR fixed linkage mechanism includes a guide slot, a heat dissipation block, a locking block and screws, the guide slot is disposed within the junction box, the dissipation block is embedded in the guide slot and tightly adhered to the surface of the cooling groove, the locking block tightly presses the SCR via screws.

5. The intelligent failure self-diagnostic convertible jet pump according to claim 4, characterized in that the outer edge of the diffuser is provided with water inlets and water outlets to form multiple sets of diversion channels, the diversion channel is sloped through the front and rear surfaces of the diffuser, the diffuser surface on the side of water outlet is provided with multiple channel walls which correspondingly match with the flow channels, the channel walls are in the shape of arc and the outer arc surface of the channel walls are closed.
